(19) United States
(12) Patent Application Publication
(10) Pub. No.: US 2026/0260559 A1
(43) Pub. Date: Sep. 3, 2026

(54) SYSTEM FOR WARNING A SHOOTER ABOUT A SHOOTING SITUATION WITH A POTENTIAL SAFETY PROBLEM

(71) Applicant: Carl Zeiss AG, Oberkochen (DE)

(72) Inventors: Alexander Tobisch, Oberkochen (DE); Steffen Urban, Jena (DE); David Dobbelstein, Oberkochen (DE); Lucian Stefan, Oberkochen (DE)

(21) Appl. No.: 19/555,777

(22) Filed: Mar. 3, 2026

(30) Foreign Application Priority Data
Mar. 3, 2025 (DE) 10 2025 108 021.6

(51) Int. Cl. G08B 25/01; G08B 7/06; G08B 21/02; G08B 21/18; H04W 4/029

(52) U.S. Cl. CPC G08B 25/016; G08B 7/06; G08B 21/02; G08B 21/182; H04W 4/029

(57) ABSTRACT

A system for warning a shooter about a shooting situation with a potential safety issue has a sensor arrangement configured to acquire a measurement variable relating to a current spatial orientation of a firearm, a data interface configured to acquire items of information relating to an environment of the shooter, an output device configured to output an optical warning message to the shooter, wherein, in an intended state of use, the output device is arranged on the firearm such that the shooter can receive the warning message in the shooting position, and a controller configured to combine the measurement variable with the items of information relating to the environment of the shooter, to determine whether a safety issue is expected in the case of a shot with the current spatial orientation, and, when a safety problem is expected, to output the warning message to the shooter with the output device.

### CROSS REFERENCE TO RELATED APPLICATIONS

This application claims priority to German patent application DE 10 2025 108 021.6, filed Mar. 03, 2025, the entire content of which is incorporated herein by reference.

### TECHNICAL FIELD

The disclosure relates to a system for warning a shooter about a shooting situation with a potential safety problem.

### BACKGROUND

When hunting, the use of firearms means that there is always a risk of causing harm to other persons or possibly also injuring animals unnecessarily. In driven hunts, for example, it thus occasionally happens that other hunters are shot. In an attempt to avoid this, the hunters on driven or drive hunts frequently wear particularly conspicuous clothing.

However, when hunting in an unknown area, too, safety risks may arise, especially for less experienced hunters, if the hunter is not aware of paths passing through the area and/or of adjacent populated regions. Likewise, however, humans in the field of fire may possibly also be overlooked when there is high concentration on the game animal.

The aforementioned safety problems, or risks of such safety problems, can be attempted to be prevented or reduced by constant training and safety briefings. Nevertheless, there is a certain residual risk if the surveillance is carried out by the hunter (shooter) themself.

It is an object of the disclosure to enable a shooting situation that is less prone to safety problems.

The object is achieved according to the disclosure by a system for warning a shooter about a shooting situation with a potential safety problem as described herein.

The system according to an aspect of the disclosure serves to warn a shooter about a shooting situation with a potential safety problem. For this purpose, the system has a sensor arrangement configured for acquiring at least one measurement variable relating to a movement and/or a current, in particular absolute, spatial orientation of a firearm. Additionally or alternatively, the system has means, in particular a data interface, for acquiring a plurality of items of information relating to an environment of the shooter, and an output device for outputting an optical warning message to the shooter. In this case, in an intended state of use, this output device is arranged on the firearm such that the shooter can receive (i.e., see or at least perceive) the warning message in the shooting position – i.e., when they are looking through or via a targeting device of the firearm. In addition, the system has a controller configured to evaluate the at least one measurement variable and/or at least one (item of information) of the plurality of items of information relating to the environment of the shooter, to determine therefrom whether a safety problem should be expected in the case of a shot under the condition of the movement or orientation and/or the information relating to the environment, and, in the event of a safety problem to be expected, to output the warning message to the shooter with the output device.

The system is advantageously used to assist the shooter in monitoring their environment, in particular their field of fire, and/or their target acquisition for potential safety problems. Although this is in principle a task of every shooter, situations may occur – as described in the introduction – in which the shooter, despite appropriate caution, may not perceive or be able to perceive every safety problem.

Typically, the system has both the sensor arrangement and the means, in particular the data interface. In this case, the controller is configured to combine the at least one measurement variable with said at least one of the plurality of items of information relating to the environment of the shooter, to determine therefrom whether a safety problem should be expected in the case of a shot, in particular with the current movement or spatial orientation, and, in the event of a safety problem to be expected, to output the warning message to the shooter with the output device.

Here and hereinafter, the term “spatial orientation” of the firearm is understood to mean an arrangement of the firearm in space. The term encompasses a relative orientation related only to a preceding orientation. This relative orientation thus reflects a change in the orientation, in particular of a rotational and/or translational kind (e.g., that is to say that the firearm was rotated by 10 degrees about the longitudinal axis). However, the term also encompasses an absolute orientation. The absolute orientation reflects in particular the orientation with reference to a coordinate system, in particular a stationary, typically global, coordinate system, i.e., whether the shooting direction of the firearm is tilted by 5 degrees relative to a horizontal plane.

In accordance with one exemplary embodiment, at least in the intended state of use, the output device is arranged on a targeting optical unit (e.g., an analog or digital telescopic sight, a night vision device, a thermal imaging device, a reflex sight or the like) connected to the firearm, and is typically coupled to the targeting optical unit on the eyepiece side. By virtue of the arrangement on the eyepiece side, the shooter can usually perceive the output device with a very high probability when they are in the shooting position and thus looking through the eyepiece of the targeting optical unit.

In one exemplary embodiment, at least of the arrangement of the output device on the targeting optical unit, the output device is configured to insert the warning message into an image visible through the targeting optical unit. This especially makes it easier to perceive the warning message and reduces the risk of overlooking it.

In accordance with a further exemplary embodiment, the output device is configured to change a luminous color and/or luminous intensity of an illuminated reticle and/or a display of the targeting optical unit as a warning message. In particular, the output device switches the luminous color to a warning color, e.g., a particularly bright red. In addition to or as an alternative to the color change, the reticle can also be illuminated in flickering (pulsating, flashing) fashion in order to increase the conspicuousness. An illuminated reticle is also known for analog targeting optical units. Further additionally or alternatively, in particular in the case of an electronic (“digital”) targeting optical unit (i.e., in particular a targeting optical unit with additional functions such as, e.g., distance measurement, thermal or night image function, etc.), the output device is configured to insert the warning message into the image that can be viewed through the eyepiece, optionally to place it over said image. Optionally, a size and/or intensity of the warning message can be varied by way of the output device (or controller) depending on the severity of the safety problem. For example, in the event of persons being endangered, the reticle can be illuminated so brightly that a target pickup is prevented or made significantly more difficult. If the warning message is inserted, it can also be displayed in this case in such a size that the warning message covers the reticle and the image of the target region. Alternatively – especially in the case of a digital targeting optical unit in which the reticle is inserted into the image presented with a display in the eyepiece – the reticle can also be displayed more faintly than usual or be masked out, so that targeting is prevented. Optionally, the entire image (i.e., in particular the display displaying the image) can also be switched off, typically in addition to the warning message or else as a warning message itself – especially in the event of persons being endangered – with the result that target observation is not made possible any more.

In accordance with one exemplary embodiment, at least the output device, typically the entire system, is integrated into the targeting optical unit.

In accordance with an alternative exemplary embodiment, at least the output device, typically the (entire) system, is reversibly couplable to the targeting optical unit, in particular connectable thereto in terms of signal transfer in the form of a module for extending the function of the targeting optical unit. In this case, the targeting optical unit expediently has an interface for data transfer with different modules, e.g., a module for distance measurement or the like.

In accordance with a further exemplary embodiment, the output device, in order typically additionally also to be able to output the warning message acoustically, has a loudspeaker or is couplable to a loudspeaker for this purpose. For example, the output device or at least the system has an audio interface for a wired, but typically wireless, coupling to a loudspeaker or a device including the latter, in particular headphones, optionally hearing protection headphones. In this case, the output device optionally has a plurality of stored, spoken warning messages or a functionality (typically an artificial intelligence) for generating (synthesizing) corresponding spoken warning messages.

In accordance with one exemplary embodiment, the sensor arrangement is formed by at least one gyroscopic sensor configured to acquire in each case a measurement variable for an elevation angle (inclination or pitch angle), a swivel angle (yaw angle) and a roll angle of the firearm, typically at least with regard to the swivel and/or inclination angle relative to a horizontal. Typically, the sensor arrangement is formed by an inertial measurement system (“IMU”), which includes the aforementioned gyroscopic sensor and typically also a compass sensor (e.g. in the form of a geomagnetic sensor, magnetometer). The controller is typically configured to derive the corresponding angle from each measurement variable. The gyroscopic sensor can in principle be a “true” gyro sensor, e.g., a laser gyroscope or the like. However, the gyroscopic sensor is typically formed by a three- or multi-axis (e.g., six-axis) acceleration sensor configured, e.g., in the form of a microelectromechanical system (“MEMS”). Such sensors and also IMUs including these sensors are known from mobile phones, for example.

Typically, the controller is configured to determine the roll angle of the firearm, in particular as an absolute spatial orientation, typically with the abovementioned IMU, and if appropriate to output a warning message that the firearm is tilted if the roll angle is larger than 15 degrees relative to a horizontal. As is known, targeting aids in conjunction with tilted firearms, with the axes thereof, no longer match the plane of the bullet trajectory, with the result that misses occur especially at relatively long distances (e.g., 100 m or more). In addition to the warning message, the controller can optionally also insert an artificial horizon into the image that can be viewed through the eyepiece of the targeting aid, in order to simplify a correction for the shooter. Tilting may occur to an increased extent – especially also for inexperienced shooters – if the surrounding terrain gives hardly any indications for orienting the firearm. This is often the case in mountainous and/or alpine terrain.

Furthermore, the controller (as an alternative or in addition to the above consideration of the roll angle) – in particular in joint consideration with a shooting distance – is expediently configured to acquire the swivel angle and/or the inclination angle and, from the temporal profile of the inclination and/or swivel angle (in particular the extrema thereof or other statistical data such as e.g. the standard deviation), to determine and specify an anticipated (e.g., maximum or mean) impact point displacement to the predicted shooting distance. In the case of an impact point displacement of larger than, e.g., 20 or 30 cm, this can also be output as a warning message, and in the case of smaller impact point displacements, e.g., also only as information. In other words, in this case, the controller is configured to deduce, on the basis of the profile of the inclination and/or swivel angle, an excessive movement of the firearm and owing to that an impact point displacement resulting in a miss with high probability. A movement of the firearm and thus also the targeting optical unit is often due to a respiratory movement that often increases after physical exertion before the shot (e.g., finding the shooting position uphill), and/or due to an insufficiently stable support for the firearm. In this case, the temporal profile of the inclination and/or swivel angle can also be determined as a relative spatial orientation, e.g., with a gyro sensor. An IMU is not required in this case, but can equally be used for this purpose.

The shooting distance can be determined for example with manual input by the shooter, typically into a mobile device (e.g., smartphone or tablet) connected to the system in terms of data transfer, or else with a distance measuring system integrated into the system or connected thereto in terms of data transfer.

In accordance with an exemplary embodiment, the data interface is configured to acquire (in particular as information relating to the environment of the shooter) location information concerning the current location of the system. For example, the location information is at least longitude and latitude specifications of the current location. In particular, the data interface is configured as a receiver of a global navigation satellite system (“GNSS”). The location information can be and is advantageously used, in an application which enables networking of various shooters, in particular hunters, and/or which provides background information concerning a field of fire, in particular a hunting area, to determine the own location and to compare it with locations of other shooters or regions with increased safety requirements (e.g., residential areas, hiking or forest paths and the like).

In accordance with a further exemplary embodiment, the data interface is configured, during intended operation, to be connected to a database and – in particular in a manner controlled by the controller – to read from it, as information relating to the environment of the shooter, topography data concerning the location information. Typically, the controller is configured to read these topography data for surroundings at a customary shooting distance, e.g., approximately 1000 meters around the location, optionally in a shooting direction up to 3000 meters. In addition, the controller is configured to determine a probability value for a ground hit within a predefined distance from the location on the basis of the spatial orientation of the firearm and to output the warning message if the probability value falls below a predefined value. In particular, the controller thus determines on the basis of the topography data whether the terrain within the predefined distance from the location of the shooter is a – typically natural – bullet trap. The predefined distance is chosen by the controller typically in the range of customary maximum hunting shooting distances, e.g., at 300 to 500 meters, and/or depending on infrastructural features in the surroundings. For example, such a bullet trap must be able already to be hit at a distance of 150 meters if there is a path running behind a mountain peak at a distance of 300 meters. Further for example, in the case of an upslope-directed shooting direction, the trajectory thereof is not permitted to run over the apex (peak) of the slope, but rather must end at the correspondingly predefined distance in the slope. Otherwise, the controller is configured to output the warning message.

In accordance with an exemplary embodiment, the data interface is configured, during intended operation, to be connected to a database and to read from it, as information relating to the environment of the shooter, information relating to surrounding regions with respect to the location information that are potentially occupied by persons. In particular, this database is accessible with and/or implemented in the abovementioned application. In particular, the data interface is also configured to transmit its own location information (in particular its own location) to the application and/or to the database. This last is expedient especially in the case where the application is configured and provided for use by hunters, in particular in a driven hunt. If the respective locations of other hunters are known in the database and thus in the application, the surrounding regions with respect to the own location in which the locations of the other persons (hunters) are situated can be marked with a warning message (“no-shooting region”, “restricted area”, “persons” or the like). For example, this can be displayed in a manner marked in a map view on a smart mobile device (smartphone). However, this warning message can likewise also be inserted in the targeting optical unit, especially if it is deter-mined on the basis of the gyroscopic sensor that the shooting direction of the firearm is swiveled in the direction of one of these “restricted areas”. Equally, an inhabited region and paths can also be displayed or marked, since in some cases these may not be directly visible from the shooter's point of view on account of tree coverage or the like.

In accordance with a further exemplary embodiment, the data interface is configured, during intended operation, to be connected to an (in particular further) database and to read from it weather information as information relating to the environment of the shooter. Air pressure, air humidity, temperature, wind speed and/or wind direction are determined as weather information. These variables are known to influence the trajectory of a bullet, at least at long shooting distances. In particular, the controller is configured to determine an anticipated deviation of the bullet from the ideal trajectory thereof on the basis of at least one, typically a plurality, of these variables. Typically, the controller is also configured to output a warning message if the predicted deviation in the target is larger than a predefined, optionally distance-dependent, limit value. For example, the controller outputs the warning message if the determined anticipated deviation is larger than 50 cm, typically larger than 20 cm. Such a large deviation may lead to an unsafe shooting situation inasmuch as a miss may cause unnecessary injury to the game animal and thus suffering.

In accordance with one advantageous embodiment, during intended operation, the controller is connected, in terms of data transfer, to an image acquisition unit of the targeting optical unit, in particular with the data interface. In this case, the controller is configured to acquire image data from the image acquisition unit, evaluate said image data with regard to the or an additional safety problem and, if appropriate, output the warning message with the output device. These image data in particular likewise form information relating to the environment of the shooter. This evaluation of the image data is additionally independent of the acquisition of the spatial orientation of the firearm.

In particular, in the case of the above evaluation with regard to the additional safety problem, the controller is configured to evaluate the image data for the presence of a person in the field of view of the targeting optical unit and thus in the field of fire. In principle, however, in the context of an independent disclosure, the controller can also be configured only for the evaluation with regard to the additional safety problem, in particular the presence of a person in the field of fire. In this case, the sensor arrangement described above may also be absent or optionally not be used (at least not continuously). The exemplary embodiment with person recognition advantageously increases safety to an exceptional extent, since the risk, with respect to the shooter, of a person being present in the field of view of the targeting optical unit but not being recognized by the shooter, e.g., on account of the shooter's high concentration on their target can thereby be reduced or even eliminated.

In accordance with one advantageous development, the controller is configured to evaluate the image data for the presence of a game animal and in particular to identify the species of game animal and to compare the species of game animal with shooting permissions for different game animals which are stored in an (in particular further) database to which the data interface is connected during intended operation. This further database can advantageously likewise be accessible by the application or integrated into the latter, as described above. The comparison is typically likewise carried out in the context of the application described above. For example, recognition of a hunting area in which the firearm (and thus the assigned hunter) is currently situated takes place, in particular on the basis of the location information. In this case, typically current shooting prohibitions and/or explicit permissions, which may be predefined, e.g., depending on the area, are stored in the cloud-based database which, e.g., is contained in the application or in particular is accessible by the latter. With the above-described comparison, therefore, for the hunter, the information is obtained and typically also displayed as a (warning) message as to whether the, e.g., currently identified game animal in the field of view of the targeting optical unit is permitted to be shot (e.g., in which case a reticle illumination lights up green) or there is currently a shooting prohibition (e.g., reticle illumination lit up red and/or additional information inserted).

In accordance with a further exemplary embodiment, the system, in particular the means for acquiring the information relating to the environment of the shooter, has a distance sensor, which, in the intended state of use, is arranged on the eyepiece side of the targeting optical unit and is optionally integrated with the output device. In this case, the controller is configured in particular to evaluate a sensor signal of the distance sensor for undershooting of a measurement variable transported therein for a distance of an object to the distance sensor and to output an assigned warning message upon a minimum distance value being undershot. This is advantageous inasmuch as there is a risk of injury if the distance between eye and eyepiece is too small, on account of recoil. Especially with fully electronic (“digital”) targeting optical units, visual anomalies if “eye distances” are too large or too small do not occur, in some instances, in the same way as with purely optical targeting optical units. Such anomalies are for example a dark edge around the image if the eye distance is too large or the absence of a thin edge if the eye distance is too small. This warning message is therefore directed at the safety of the shooter themself, in order that the shooter is not injured by the targeting optical unit when the shot breaks and the firearm “kicks” backward as a result of the recoil.

In accordance with a further exemplary embodiment, for the purpose of outputting the respective warning message (optionally in addition or as an alternative to inserting the warning message into the targeting optical unit, e.g., in the form of different-colored and/or flashing reticle illumination), the output device has at least one illuminant visible to the shooter and/or a display. This exemplary embodiment is expedient especially if the system or at least the output device can be mounted as a module on the targeting optical unit. Illuminants are for example one or more LEDs arranged facing toward the shooter in the intended state of use. The display advantageously likewise faces the shooter, but can optionally also be configured to be hinged, such that the shooter can firstly look at the display when the firearm is put down, but when preparing to shoot with the firearm can line up the display and thus continue to observe it also from a region behind the targeting optical unit.

The controller is optionally at least essentially formed by a microcontroller with a processor and a data memory, in which the functionality described above is implemented in terms of programming in the form of operating software (firmware). Alternatively, however, the controller can also be formed by a non-programmable electronic component, e.g., an application-specific integrated circuit (ASIC), in which the functionality is implemented using circuitry means.

Here and hereinafter, the conjunction “and/or” should be understood to mean in particular that the features linked by this conjunction can be embodied both jointly and as alternatives relative to one another.

### BRIEF DESCRIPTION OF THE DRAWINGS

The disclosure will now be described with reference to the drawings wherein:

FIG. 1 shows, in a basic schematic diagram, a telescopic sight with a system for warning a shooter,

FIGS. 2 to 5 show various perspective illustrations of exemplary embodiments of the system, and

FIGS. 6 to 9 show various application examples of the system.

### DESCRIPTION OF EXEMPLARY EMBODIMENTS

Mutually corresponding parts are provided with the same reference signs throughout the figures.

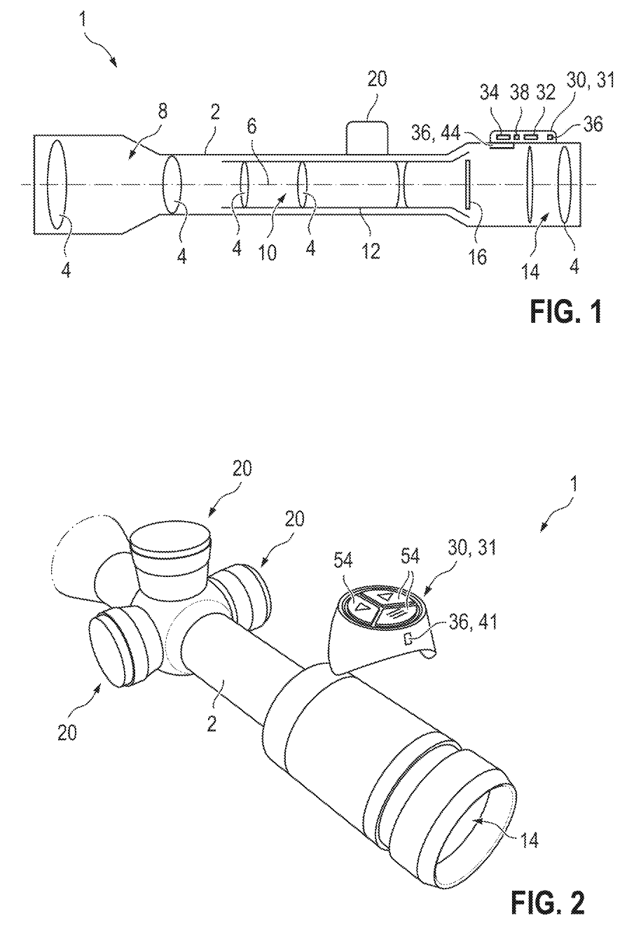

FIG. 1 shows a basic schematic diagram of a targeting optical unit, here specifically of a telescopic sight 1, for a firearm. The telescopic sight 1 has a tubular (outer) housing 2, in which a plurality of lenses 4 are arranged successively along a light path 6. In this case, the lenses 4 form at least one objective lens group 8 and a lens group of a so-called erecting system 10, which is arranged in an “inner tube” 12, i.e., a tubular holder, on the image side following the objective lens group 8 in the housing 2. A further lens group, which forms an eyepiece 14, is arranged in the housing 2 on the image side following this erecting system 10. In the illustrated exemplary embodiment, a reticle element 16 is arranged on the eyepiece-side end of the inner tube 12. This reticle element 16 is formed for example by a glass pane bearing a reticle marking printed, etched or otherwise made visible thereon. This reticle marking brings about a reticle 18 (cf. FIG. 6) in an image visible through the eyepiece 14. The housing 2 carries an adjustment turret 20 including an adjustment mechanism (not illustrated in more specific detail), which in the present exemplary embodiment acts on the inner tube 12 and, upon actuation, tilts the erecting system 10 relative to an optical axis (here in a neutral position of the erecting system 10 for example congruently with the light path 6). The reticle element 16 is arranged on the image-side end of the erecting system 10 at the pivot point of the inner tube 12, such that the reticle element 16 itself remains virtually stationary. A relative adjustment of the reticle 18 in the image that can be viewed by a user (shooter) is brought about by the tilting of the erecting system 10.

In an alternative exemplary embodiment, not illustrated, the reticle element 16 is arranged between the objective lens group 8 and the erecting system 10. In this case, the adjustment mechanism acts on the reticle element 16 and offsets it relative to an optical axis of the objective lens group 8.

The telescopic sight 1 is assigned a system (“auxiliary system” 30) for warning the shooter about a shooting situation with a potential safety problem. A system module 31 of the auxiliary system 30 is arranged on the objective side of the housing 2 of the telescopic sight 1.

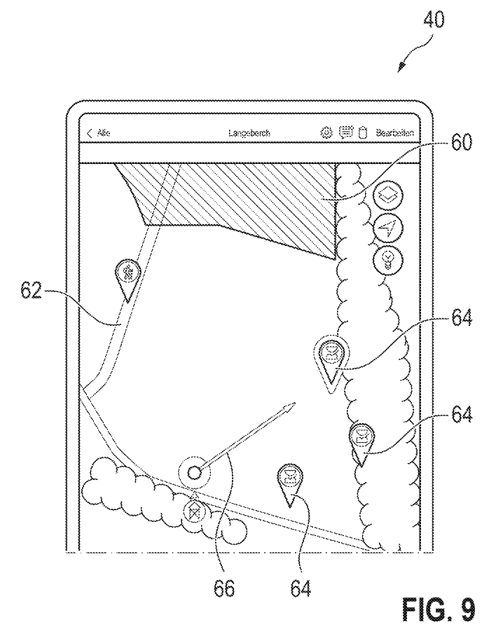

The auxiliary system 30 has a sensor arrangement 32 configured to acquire at least one measurement variable relating to a spatial orientation of the firearm. Furthermore, the auxiliary system 30 has a data interface 34 for acquiring a plurality of items of information relating to an environment of the shooter, and an output device 36 for outputting an optical warning message to the shooter. Furthermore, the auxiliary system 30 has a controller (controller 38). The controller 38 is arranged in the system module 31 in the present exemplary embodiment. In principle, however, the controller 38 can also be integrated, in particular implemented in terms of software, in a smart mobile device (smartphone 40, see FIG. 9). In this case, data are transferred between the smartphone 40 and the system module 31 by radio (in accordance with the Bluetooth standard or the like). In the latter case, the data interface is configured and provided for communication with the (external) controller 38. However, a corresponding data interface is likewise assigned to the external controller 38, e.g., in the form of an Internet interface of the smartphone 40. Further optionally, however, the system module 31 can also include the controller 38 and also – in the state coupled to the smartphone 40 – use the controller thereof. Computation tasks can be processed in a distributed manner (“distributed controller”).

FIGS. 2 to 5 illustrate various exemplary embodiments showing a securing or integration of the system module 31 in or on the telescopic sight 1. FIG. 2 shows an exemplary embodiment in which the system module 31 is formed independently of the telescopic sight 1 and specifically can be secured to any telescopic sight 1. For example, the system module 31 is adhesively bonded onto the housing 2 of the telescopic sight 1 or secured with a clip (not illustrated) or the like. In this case, the output device 36 has at least one LED 41, which is typically configured for lighting up in different colors, in particular red and green. This LED 41 is arranged at a point on the system module 31 which can be seen by the shooter looking into the eyepiece 14 of the telescopic sight 1, at least with their gaze being turned only slightly away from the eyepiece 14. At the very least, the shooter can perceive the illumination of the LED 41 at the edge of their field of view.

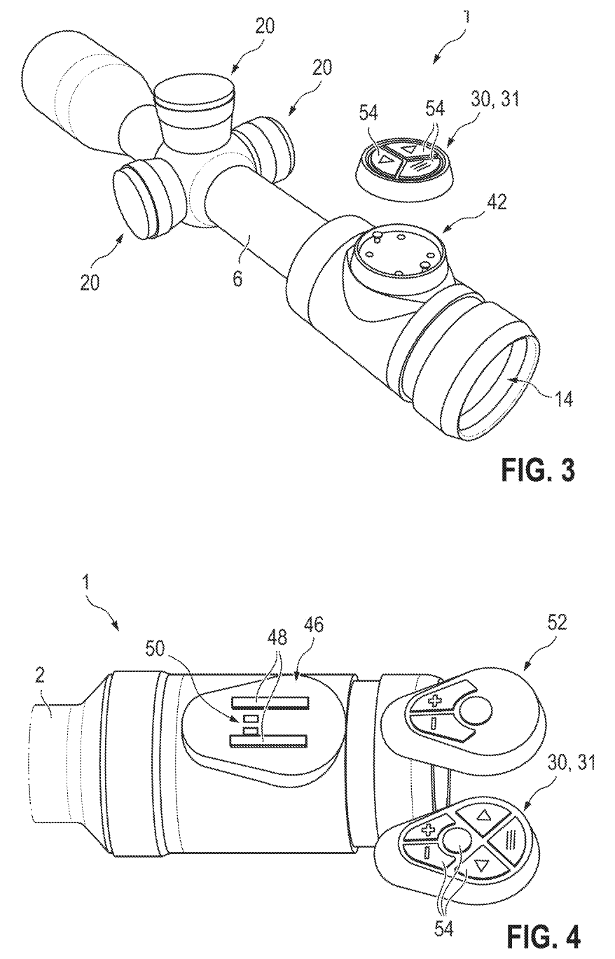

FIGS. 3 and 4 illustrate variants in which at least a mechanical coupling between the telescopic sight 1 and the system module 31 can be reversibly produced. In FIG. 3, a circular receptacle 42, similar to an adjustment turret, is formed on the housing 2 of the telescopic sight 1. The receptacle 42 is configured to hold the system module 31 with a kind of bayonet connection. In this case, the output device 36 is formed, inter alia, by a reticle illumination 44 (cf. FIG. 1). The reticle illumination 44 is already integrated into the telescopic sight 1, but can be activated and deactivated by an external control signal. Control with such a control signal is effected by a corresponding signal output by the controller 38. Signal transfer is effected by contacts (not illustrated in more specific detail) integrated into the receptacle 42. Consequently, the reticle illumination forms a part of the auxiliary system 30 at least in the intended state of use.

FIG. 4 illustrates a kind of dovetail receptacle 46. The latter has two parallel rails 48 with (in particular each facing away from one another) undercuts onto which is pushed the system module 31 with diametrically opposed rails or grooves (none of which is illustrated in more specific detail). In addition, two contact surfaces 50 are formed on the dovetail receptacle 46, and are contacted with corresponding spring contacts (not illustrated in more specific detail) of the system module 31 in the intended mounting position. FIG. 4 illustrates a second module 52, which can be secured to the telescopic sight 1 instead of the system module 31. For example, this module 52 forms a so-called rangefinder, with which, in addition to the reticle, distance data can be inserted into an image visible through the eyepiece 14.

With the contact surfaces 50, control signals output by the controller 38 can be received in the telescopic sight 1 and can be used, e.g., to change a luminous color of the reticle element 16.

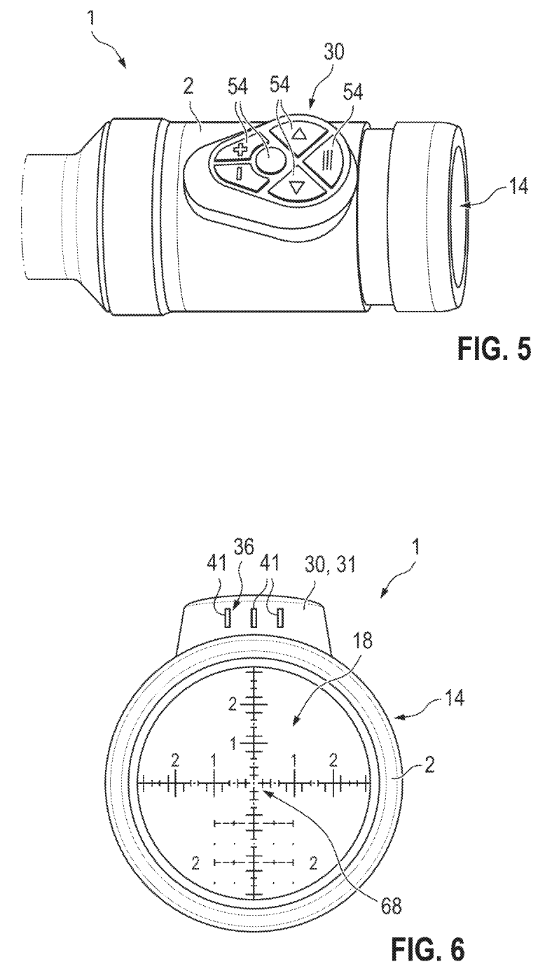

FIG. 5 illustrates an exemplary embodiment in which the auxiliary system 30 is integrated into the telescopic sight 1. Although the auxiliary system 30 is accessible from a top side of the telescopic sight 1, it is not detachable from the latter.

As can be gathered from FIGS. 2 to 5, the auxiliary system 30 has one or a plurality of buttons 54 on a top side in order to activate the auxiliary system 30, deactivate it and/or optionally select different functions.

Functionalities of the auxiliary system 30 are described in more specific detail below, in particular with reference to FIGS. 6 to 9.

During intended operation (active state) of the auxiliary system 30, the latter is connected to the smartphone 40 with the data interface 34. The sensor arrangement 32 has an inertial measurement system (IMU) including a gyro sensor, for example a MEMS acceleration sensor that is sensitive along and around three mutually perpendicular spatial directions, and a magnetometer. On the basis of the sensor signal thereof, the controller 38 determines a current absolute orientation (inclination or elevation angle, swivel or yaw angle and roll angle) of the firearm in space, specifically on the basis of the assumption that the telescopic sight 1 is connected to the firearm as intended. From the smartphone 40, the controller 38 (via the data interface 34) obtains location information concerning the current location of the user of the firearm (the shooter, e.g., a hunter). On the basis of the current location, the controller 38 determines, as information relating to the surroundings of the hunter, where there are safety-relevant regions (“restricted regions”) in the surroundings of the hunter. In particular, in the case of indirect determination, the controller 38 uses an application installed on the smartphone 40, and thus also the microprocessor of the smartphone 40 (“distributed controller”). The application accesses map material which is stored in a specific database and which designates (e.g., in general or in particular for different hunting areas) restricted areas 60, e.g., on account of habitation or paths, in the direction of which shooting must not or should not take place. Furthermore, the application is advantageously also configured to record the locations of other shooters, especially hunters, who are likewise using this application. Optionally, the application displays such a map with restricted areas 60, paths 62 and also locations of other persons 64 on a display of the smartphone 40 (see FIG. 9). The application likewise also displays the own location and, proceeding therefrom, the shooting direction 66 of the own firearm (determined with the aid of the gyro sensor). This last is advantageous especially for driven hunts or the like. The application thus forms a part of the auxiliary system 30 during intended use thereof.

However, the controller 38 is moreover also configured to output a warning message with the output device 36 in the field of view of the hunter if the orientation of the firearm (of the telescopic sight 1) would lead to a shot in the direction of a restricted area 60, another hunter (person 64) or else a path 62 potentially being used. As a warning message, in the exemplary embodiment in accordance with FIG. 2 “only”, the respective light-emitting diode (LED) 41 of the output device 36 lights up, in particular with warning color red.

In addition or else as an alternative to the above-described determination as to whether the firearm is directed in the direction of a restricted region, the controller 38 can also be configured to read from the map material topography information – i.e., three-dimensional terrain shapes – or to obtain such information with the data interface 34. The controller 38 compares this topography information with the (absolute) spatial orientation of the firearm and determines whether (or with what probability) the predicted trajectory of a bullet, i.e., specifically the anticipated trajectory, within a predefined distance from the firearm (e.g., within 400 meters) would hit the ground. If the trajectory does not (or with sufficient probability does not) hit the ground within this distance, the controller 38 interprets this as an unsafe shooting situation and outputs the or a corresponding warning message.

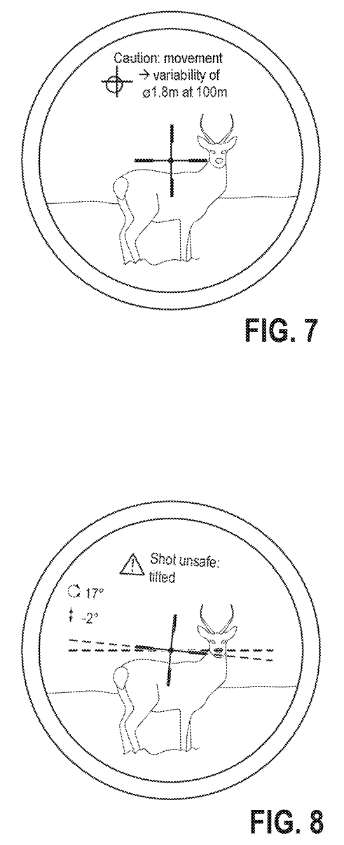

FIG. 6 illustrates a further-reaching exemplary embodiment. Here, the telescopic sight 1 has the reticle illumination 44, and the auxiliary system 30 is coupled to this (the telescopic sight 1) in terms of signal transfer (exemplary embodiments in accordance with FIGS. 3 and 4 and also 5). Depending on the exemplary embodiment of the telescopic sight 1, only one luminous point (cf. FIG. 7) or a central region 68 of the reticle 18 (FIG. 6) lights up when the reticle illumination 44 is activated. As color of the warning message, use is made of a signal color, e.g., a red perceived to be bright, or additionally or alternatively also flashing of the illuminated partial element (luminous point or central region 68). This draws the attention of the shooter (hunter) to the warning message. In addition, the LEDs 41 optionally present can also light up.

Depending on the exemplary embodiment of the telescopic sight 1 and also of the auxiliary system 30, a text-based warning message is optionally possible, too, which is out-put via a display (not illustrated in more specific detail). For example, such a display can be arranged on the system module 31 instead of the LEDs 41, in the field of view of the shooter. In the case of a digital telescopic sight 1, a kind of head-up display function can also be realized, wherein a text is inserted into the image that can be viewed through the eyepiece 14. This last is illustrated by way of example in FIGS. 7 and 8. Furthermore, the entire image that can be viewed in the eyepiece 14 can also be generated by a display – e.g., in the case of augmented optics, e.g., night vision or thermal imaging devices. In this case, the reticle is also generated digitally. In this case, the reticle and/or the viewable image can optionally also be switched off as a warning message.

Over and above the above-described warning (warning message) based on the orientation and the location of the firearm, in a further-reaching exemplary embodiment the controller 38 is configured to track a movement of the firearm with the gyro sensor, i.e., to determine the temporal profile of the spatial orientation. The controller 38 is configured to determine whether the firearm is moving “too much”, for example because the shooter (hunter) has exerted physical effort before an intended shot. If the profile of the orientation shows a sustained movement exceeding a limit value (e.g., for more than 10 seconds), the controller 38 outputs a corresponding warning (warning message). Optionally, the controller 38 additionally determines a shooting distance. For the latter, the controller uses 38, e.g., a laser distance measuring function of the telescopic sight 1 or calculates the shooting distance on the basis of image recognition and a thus recognized game animal species (and on the basis of variables typical thereof). For this purpose, the controller 38 typically uses an artificial intelligence, e.g., a neural network or the like. Typically, a corresponding evaluation is carried out on the microprocessor of the smartphone 40. For this purpose, the telescopic sight 1 additionally has means for image acquisition, e.g., an image sensor. From the profile of the elevation angle and/or the swivel angle and the shooting distance, the controller 38 determines an anticipated deviation of an impact point in the target. If this deviation is too large (e.g., larger than 50 cm at 100 m), the controller 38 outputs a corresponding warning – here inserted in text form into the image in the eyepiece 14. For image recognition, the controller 38 is connected to the telescopic sight 1, specifically to the image sensor thereof, with the data interface 34 or a further data interface.

FIG. 8 illustrates an exemplary embodiment pertaining to undesirable tilting of the firearm. This is determined by the controller 38 on the basis of the roll angle. If the latter is more than 10 degrees, the controller 38 likewise outputs a corresponding warning message.

In a further exemplary embodiment, not illustrated in more specific detail, in which the controller 38 (or the “distributed controller”) is likewise configured for image recognition, the controller 38 determines whether persons are recognizable (i.e., present) in the field of view of the telescopic sight 1. If this is the case, the controller 38 likewise outputs a warning message.

Likewise in the case of image recognition, the controller 38 is optionally configured to determine a species of a game animal in the field of view of the telescopic sight 1 and to compare it with a database available in the abovementioned application, in which database shooting permissions and/or shooting prohibitions at least for the current hunting area are managed. A warning message is output if the recognized game animal is not permitted.

In a further exemplary embodiment, the controller 38 is configured to obtain weather data such as air pressure, air humidity, temperature and wind speed and wind direction from a corresponding database (in particular via the abovementioned application). On the basis of these weather data, and also the orientation and the location, the controller 38 determines an anticipated deviation of the impact point in the target, typically also on the basis of the shooting distance. Such calculations or at least estimations are known from the field of precision shooters and are taken into account here at least for long shooting distances. This can be advantageous especially when hunting in mountainous terrain, since here there are often comparatively long shooting distances and also large inclination angles of the firearm (shots uphill or downhill).

Likewise in the case of image recognition, the controller 38 is optionally configured to determine whether there is an unobstructed view of the target (game animal) or this is restricted, e.g., on account of rain, snowfall or fog. In the case of such a re-striction, a warning can be output, since, e.g., rain and snow may not be very conspicuous on account of the magnification of the telescopic sight 1, but may nevertheless influence the shot.

The subject matter of the disclosure is not restricted to the exemplary embodiments described above. Rather, further embodiments of the disclosure can be derived from the above description by a person skilled in the art. In particular, the individual features of the disclosure described with reference to the various exemplary embodiments, and the design variants thereof, can also be combined with one another in a different way.

### LIST OF REFERENCE NUMERALS

1 Telescopic sight
2 Housing
4 Lens
6 Light path
8 Objective lens group
10 Erecting system
12 Inner tube
14 Eyepiece
16 Reticle element
18 Reticle
20 Adjustment turret
30 Auxiliary system
31 System module
32 Sensor arrangement
34 Data interface
36 Output device
38 Controller
40 Smartphone
41 LED
42 Receptacle
44 Reticle illumination
46 Dovetail receptacle
48 Rail
50 Contact surfaces
52 Module
54 Button
60 Restricted area

62 Path

64 Persons

66 Shooting direction

68 Central region

What is claimed is:

1. A system for warning a shooter about a shooting situation with a potential safety issue, the system comprising:
at least one sensor arrangement configured to acquire at least one measurement variable relating to a movement and/or a current absolute spatial orientation of a firearm, and/or means for acquiring a plurality of items of information relating to an environment of the shooter;
an output device configured to output an optical warning message to the shooter, wherein, in an intended state of use, the output device is arranged on the firearm such that the shooter can receive the warning message in a shooting position, and
a controller configured to:
evaluate the at least one measurement variable and/or at least one of the plurality of items of information relating to the environment of the shooter,
determine whether a safety issue should be expected in a case of a shot under a condition of the movement or orientation and/or the information relating to the environment, and
when the safety issue is expected, output the warning message to the shooter with the output device.

2. The system as claimed in claim 1, wherein the controller is further configured to:
combine the at least one measurement variable with at least one of the plurality of items of information relating to the environment of the shooter,
determine whether a safety issue should be expected in the case of a shot with the current spatial orientation, and,
when the safety issue is expected, output the warning message to the shooter with the output device.

3. The system as claimed in claim 1, wherein, at least in the intended state of use, the output device is arranged on a targeting optical unit connected to the firearm on an eyepiece side.

4. The system as claimed in claim 3, wherein the output device is configured to insert the warning message into an image visible through the targeting optical unit.

5. The system as claimed in claim 4, wherein the output device is configured to change a luminous color and/or luminous intensity of an illuminated reticle as a warning message.

6. The system as claimed in claim 3, wherein at least the output device is integrated into the targeting optical unit.

7. The system as claimed in claim 3, wherein at least the output device is reversibly couplable to the targeting optical unit.

8. The system as claimed in claim 1, wherein, to additionally acoustically output the warning message, the output device includes a loudspeaker or is couplable to a loudspeaker.

9. The system as claimed in claim 1, wherein the sensor arrangement is formed by at least one gyroscopic sensor configured to acquire a measurement variable for an elevation angle, a swivel angle, and a roll angle of the firearm.

10. The system as claimed in claim 2, wherein the means for acquiring the plurality of items of information relating to the environment of the shooter include a data interface configured to acquire location information concerning the current location of the system.

11. The system as claimed in claim 10, wherein the data interface is configured, during an intended operation, to be connected to a database and to read from the database, as information relating to the environment of the shooter, topography data concerning the location information, and
wherein the controller is further configured to:
determine a probability value for a ground hit within a predefined distance from the location based on the spatial orientation of the firearm, and
output the warning message when the probability value falls below a predefined value.

12. The system as claimed in claim 10, wherein the data interface is configured, during an intended operation, to be connected to a database and to read from the database, as information relating to the environment of the shooter, information relating to surrounding regions with respect to the location information that are potentially occupied by persons.

13. The system as claimed in claim 10, wherein the data interface is configured, during an intended operation, to be connected to a database and to read from the database weather information as information relating to the environment of the shooter.

14. The system as claimed in claim 3, wherein, during an intended operation, the controller is connected, in terms of data transfer, to an image acquisition unit of the targeting optical unit with the data interface, and
wherein the controller is further configured to:
acquire image data from the image acquisition unit,
evaluate the image data with regard to the safety issue or an additional safety issue, and
output the warning message with the output device.

15. The system as claimed in claim 14, wherein the controller is further configured to evaluate the image data for a presence of a person.

16. The system as claimed in claim 14, wherein the controller is further configured to:
evaluate the image data for a presence of a game animal, and
compare the image data with shooting permissions for different game animals stored in a database to which the data interface is connected during the intended operation.

17. The system as claimed in claim 3, wherein the means for acquiring the information relating to the environment of the shooter include a distance sensor, which, in the intended state of use, is arranged on the eyepiece side of the targeting optical unit and which is integrated with the output device, and
wherein the controller is further configured to:
evaluate a sensor signal of the distance sensor for undershooting of a measurement variable transported therein for a distance of an object to the distance sensor, and
output an assigned warning message upon a minimum distance value being undershot.

18. The system as claimed in claim 1, wherein, to output the respective warning message, the output device has at least one illuminant visible to the shooter and/or a display.
